(19) United States
(12) Patent Application Publication
(10) Pub. No.: US 2002/0189658 A1
(43) Pub. Date: Dec. 19, 2002

(54) Crutch

(76) Inventor: Shia-Kan Wang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/883,815

(22) Filed: Jun. 18, 2001

(51) Int. Cl. A61H 3/02

(52) U.S. Cl. 135/68

(57) ABSTRACT

A crutch has two bow tubes, a pipe clamped by lower portions of the bow tubes, a hollow mount receiving a lower end of the pipe, an extensible rod inserted through the hollow mount and disposed beneath the pipe, and two columns disposed in the hollow mount. The columns are inserted in the bow tubes. The pipe has two flap plates. Each bow tube has an incurved portion contacting the pipe and a through hole to receive one of the flap plates.

### BACKGROUND OF THE INVENTION

The present invention relates to a crutch. More particularly, the present invention relates to a crutch for facilitiating a user.

Referring to FIGS. 1 to 3, a conventional crutch 1 has a pad 11, two bow tubes 12 connected to the pad 11 downward, a handpiece 13 connected to the bow tubes 12 transversely, a pipe 14 clamped by the lower portions of two bow tubes 12, an extensible rod 16 inserted beneath the pipe 14, a tip cushion 17 receiving the lower end of the extensible rod 16, and a mount 15 confining the lower ends of the pipe 14 and the bow tubes 12. A plug 142 is disposed on the upper end of the pipe 14. Each bow tube 12 has a plurality of positioning holes 120. A bolt 131 and a butterfly nut 132 fasten the handpiece 13 and two bow tubes 12 together. The pipe 14 has a plurality of adjusting holes 140. A protrusion 141 is disposed in the pipe 14 and inserted in one of the adjusting holes 140. Two rivets 18 each fastens one of the bow tubes 12 and the pipe 14 together. The pipe 14 has two outer flanges 143 contacting the bow tubes 12. However, the conventional crutch 1 has a plurality of pins (not shown in the figures) and rivets 18 in order to assemble the crutch 1. Therefore, it is very difficult to assemble the crutch 1.

### SUMMARY OF THE INVENTION

An object of the present invention is to provide a crutch which can be assembled easily.

Another object of the present invention is to provide a crutch which can be assembled without rivets.

Accordingly, a crutch comprises two bow tubes, a pipe clamped by lower portions of the bow tubes, a hollow mount receiving a lower end of the pipe, an extensible rod inserted through the hollow mount and disposed beneath the pipe, and two columns disposed in the hollow mount. The columns are inserted in the bow tubes. The pipe has two flap plates. Each bow tube has an incurved portion contacting the pipe and a through hole to receive one of the flap plates. The columns press the flap plates upward.

### BRIEF DESCRIPTION OF THE DRAWINGS

FIG. 1 is a perspective assembly view of a conventional crutch of the prior art;

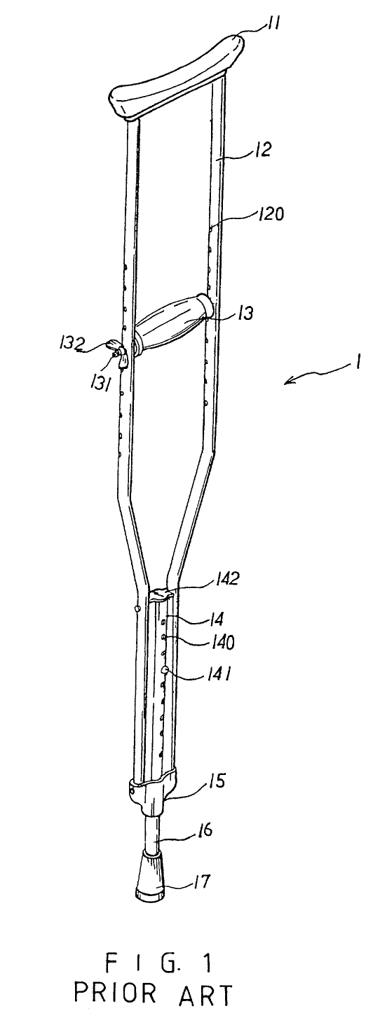

FIG. 2 is a partially sectional view of a conventional crutch of the prior art;

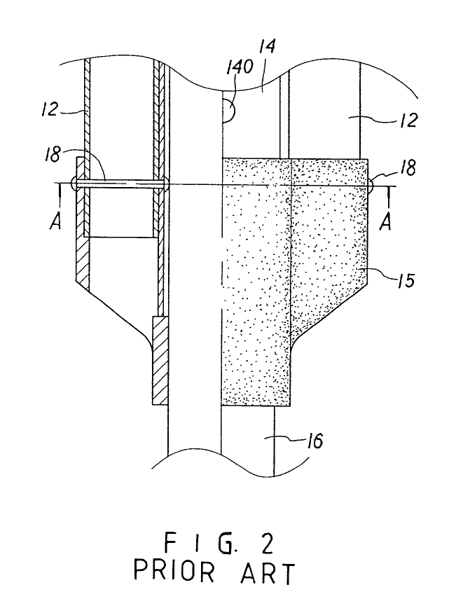

FIG. 3 is a sectional view taken along line 3A-3A in FIG. 2;

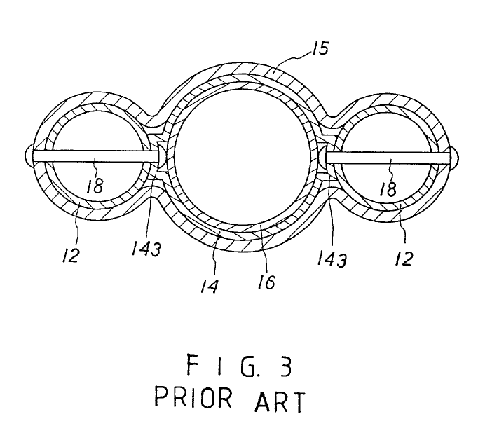

FIG. 4 is a partially perspective exploded view of a crutch of a preferred embodiment in accordance with the present invention;

FIG. 5 is a sectional assembly view of FIG. 4;

FIG. 6 is a schematic view illustrating two columns pressing two flap plates upward; and

FIG. 7 is a sectional view taken along line 7B-7B in FIG. 6.

### DETAILED DESCRIPTION OF THE INVENTION

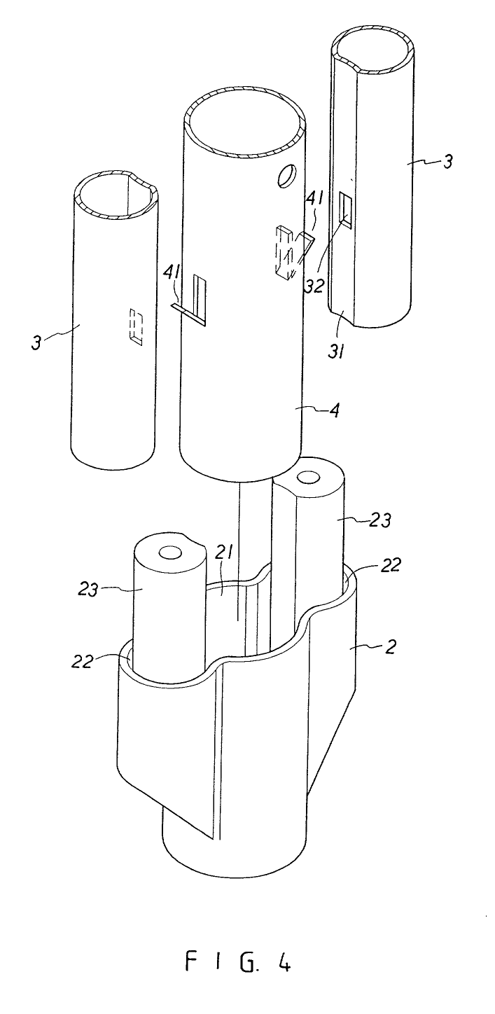

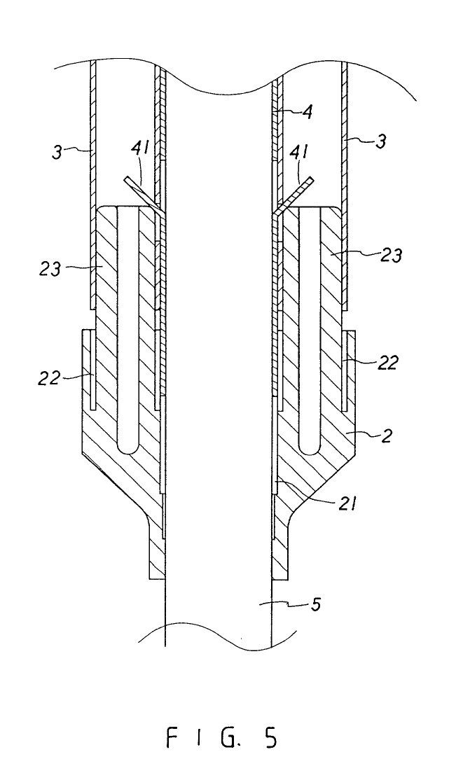

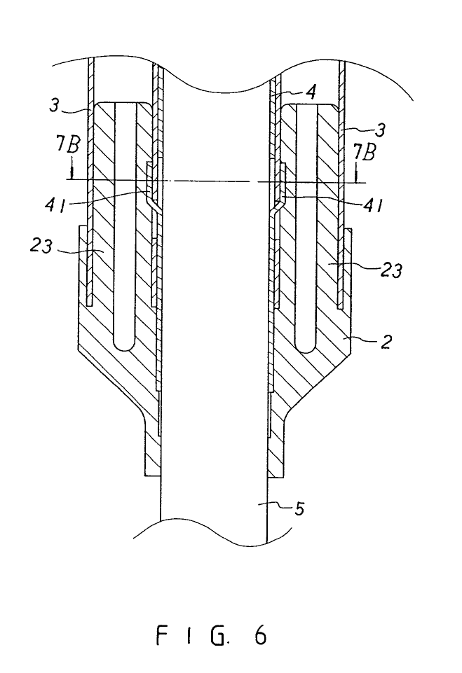

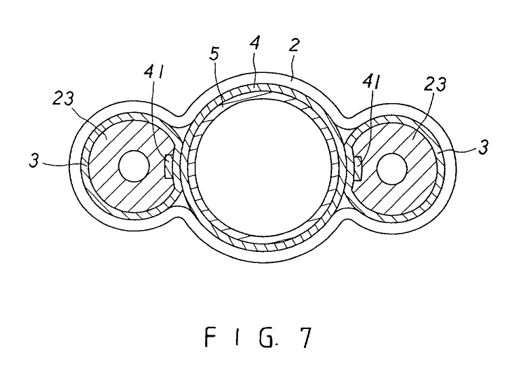

Referring to FIGS. 4 to 7, a crutch comprises two bow tubes 3, a pipe 4 clamped by lower portions of the bow tubes 3, a hollow mount 2 receiving a lower end of the pipe 4, an extensible rod 5 inserted through the hollow mount 2 and disposed beneath the pipe 4, and two columns 23 disposed in the hollow mount 2.

The columns 23 are inserted in the bow tubes 3.

The pipe 4 has two flap plates 41.

Each bow tube 3 has an incurved portion 31 contacting the pipe 4 and a through hole 32 to receive one of the flap plates 41.

The columns 23 press the flap plates 41 upward.

The hollow mount 2 has a chamber 21, and two spacings 22 defined by the columns 23 and the hollow mount 2.

Since the columns 23 are inserted in the bow tubes 3, the engagement of the pipe 4, the hollow mount 2, and the bow tubes 3 becomes very stable.

The pipe 4 does not need any outer flange.

The crutch is assembled without rivets.

The present invention is not limited to the above embodiment but various modification thereof may be made. Furthermore, various changes in form and detail may be made without departing from the scope of the present invention.

I claim:

1. A crutch comprises:
two bow tubes,
a pipe clamped by lower portions of the bow tubes,
a hollow mount receiving a lower end of the pipe,
an extensible rod inserted through the hollow mount and disposed beneath the pipe,
two columns disposed in the hollow mount,
the columns inserted in the bow tubes,
the pipe having two flap plates, and
each of the bow tubes having an incurved portion contacting the pipe and a through hole to receive one of the flap plates.

2. The crutch as claimed in claim 1, wherein the hollow mount has a chamber, and two spacings defined by the columns and the hollow mount.
